(19) United States
(12) Patent Application Publication
(10) Pub. No.: US 2026/0013516 A1
(43) Pub. Date: Jan. 15, 2026

(54) COMPOSITIONS COMPRISING KOCHIA EXTRACTS AND METHODS OF MAKING, USING, AND DETECTING SUCH COMPOSITIONS

(71) Applicant: Pollen Energy Biostimulant LLC, Portland, OR (US)

(72) Inventor: Hao Xu, Chengdu City (CN)

(21) Appl. No.: 19/263,279

(22) Filed: Jul. 8, 2025

Related U.S. Application Data
(60) Provisional application No. 63/668,891, filed on Jul. 9, 2024.

(51) Int. Cl. A01N 65/08; A01P 21/00; G01N 30/02; G01N 30/30; G01N 30/74; G01N 30/86; G01N 30/88

(52) U.S. Cl. CPC A01N 65/08; A01P 21/00; G01N 30/30; G01N 30/74; G01N 30/8631; G01N 2030/027; G01N 2030/8813

(57) ABSTRACT

The disclosure relates to the technical field of agriculture, and in particular relates to the application of Kochia scoparia extracts in plant growth. Disclosed is a composition including Kochia extract and method of promoting plant growth by treating a plant with a composition including Kochia extract. The Kochia extract disclosed herein is an extract from a part of a Kochia scoparia (L.) Schrad plant, such as the root, stem, leaf, and/or fruit of the plant.

### CROSS REFERENCE TO RELATED APPLICATION

The present application claims the benefit of priority to U.S. Provisional Application No. 63/668,891, filed Jul. 9, 2024, the entirety of which is incorporated herein by reference.

### BACKGROUND

The disclosure relates to the technical field of agriculture, and in particular relates to the application of Kochia extract in plant growth.

Kochia is Kochia scoparia (L.) Schrad, a type of Chenopodiaceae plant. It is native to Europe and central and southern Asia. It has strong adaptability and has no strict soil requirements. It is widely distributed in Europe, Asia, Africa and other places. Kochia is mostly used as a horticultural landscape plant, and its fruit can be used as medicine after being dried and has benefits such as anti-inflammatory, anti-fungal, anti-allergic and hypoglycemic etc. However, in the field of agriculture, the use of Kochia and its extract is rare. Kochia scoparia is the main medicinal part, but there are few studies on the use of its roots, stems, leaves and other parts, and there are no reports on its application in plant growth.

### SUMMARY

One aspect provided herein is a composition comprising Kochia extract.

In some embodiments, the Kochia extract comprises an extract from a part of a Kochia scoparia (L.) Schrad plant, and the part is selected from the group of root, stem, leaf, fruit, and mixtures thereof. In some embodiments, the part is fruit.

In some embodiments, the composition is in a form selected from the group consisting of cream, suspension, powder, granule, and solution.

In some embodiments, the Kochia extract is an extract of water and/or an organic solvent.

In some embodiments, the organic solvent is selected from the group consisting of alcohol, ester, ketone, sherwood oil, and mixtures thereof.

In some embodiments, the alcohol is selected from the group consisting of ethanol, hydrous ethanol, methanol, hydrous methanol, n-butanol, hydrous n-butanol, and mixtures thereof; the ester is selected from the group consisting of ethyl acetate, methyl acetate, and mixtures thereof; and the ketone comprises acetone.

In some embodiments, the composition further comprises a material selected from the group consisting of dispersants, wetting agents, binders, emulsifying agents, stabilizers, solvents, and mixtures thereof.

In some embodiments, the composition further comprises a component selected from the group consisting of foliar fertilizers, water-soluble fertilizers, compound fertilizers, pesticides, and mixtures thereof.

In some embodiments, the composition comprises the Kochia extract in a concentration of 0.01˜200 ppm. Another aspect provided herein is a method of promoting plant growth, the method comprising treating a plant with a composition comprising Kochia extract.

In some embodiments, the Kochia extract comprises an extract from a part of a Kochia scoparia (L.) Schrad plant, and the part is selected from the group of root, stem, leaf, fruit and mixtures thereof. In some embodiments, the part is fruit.

In some embodiments, the composition comprises the Kochia extract in a concentration of 0.01˜200 ppm.

In some embodiments, the Kochia extract provided herein or a composition comprising the Kochia extract provided herein is tested by high performance liquid chromatography at conditions comprising:
column: C18
mobile phase gradient elution conditions:

| | | 0.01-1.0% Acid |
|---|---|---|
| Time (min) | Acetonitrile % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

the acid aqueous solution comprises an acid selected from phosphoric acid, acetic acid, formic acid, trifluoroacetic acid, and mixtures thereof,
a concentration of the aqueous acid solution is 0.01˜0.2%,
column temperature: 30-40° C.,
detection wavelength: 355±5 nm, and
flow rate: 0.5˜1.2 mL/min, and
   the obtained chromatogram has at least one of the following:
when the Kochia extract is a Kochia fruit extract, characteristic peaks include one or more of 4.1±0.5 min, 18.6±0.5 min, or 25.4±0.5 min;
when the Kochia extract is a Kochia root extract, characteristic peaks include at least 4.1±0.5 min;
when the Kochia extract is a Kochia stem extract, characteristic peaks include at least one or more of 4.1±0.5 or 18.6±0.5 min; or
when the Kochia extract is a Kochia leaf extract, characteristic peaks include at least one or more of 4.1±0.5 or 18.6±0.5 min.

Another aspect provided herein is a method of promoting plant growth, the method comprising treating a plant with a composition comprising Kochia extract.

In some embodiments, the Kochia extract comprises an extract from a part of a Kochia scoparia (L.) Schrad plant, and the part is selected from the group of root, stem, leaf, fruit, and mixtures thereof.

In some embodiments, the part is fruit.

In some embodiments, the composition comprises the Kochia extract in a concentration of 0.01˜200 ppm.

In some embodiments, the method further comprises treating the plant with another composition selected from the group consisting of foliar fertilizers, water-soluble fertilizers, compound fertilizers, pesticides, and mixtures thereof.

In some embodiments, the promoting plant growth is selected from the group consisting of promoting seed germination; promoting growth of one or more of roots, stems, leaves or flowers and fruits; and combinations thereof.

In some embodiments, the plant is selected from the group consisting of tobacco leaves, corn, lettuce, wheat, capsicum, Chinese cabbage, lettuce, Brassica chinensis L., tomato, citrus, kiwi, cherry, pear, apple, and combinations thereof.

In some embodiments, the treating the plant is selected from the group consisting of soaking a seed of the plant, spraying a leaf of the plant, irrigating a root of the plant, and combinations thereof.

In some embodiments, the method comprises testing the composition by high performance liquid chromatography at conditions comprising:
column: C18
mobile phase gradient elution conditions:

| | | 0.01-1.0% Acid |
|---|---|---|
| Time (min) | Acetonitrile % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

the acid aqueous solution comprises an acid selected from phosphoric acid, acetic acid,
formic acid, trifluoroacetic acid, and mixtures thereof, a concentration of the aqueous
acid solution is 0.01˜0.2%, column temperature: 30-40° C.,
detection wavelength: 355±5 nm, and
flow rate: 0.5˜1.2 mL/min, and
   obtaining a chromatogram having at least one of the following:
when the Kochia extract is a Kochia fruit extract, characteristic peaks include one or more of 4.1±0.5 min, 18.6±0.5 min, or 25.4±0.5 min;
when the Kochia extract is a Kochia root extract, characteristic peaks include at least 4.1±0.5 min;
when the Kochia extract is a Kochia stem extract, characteristic peaks include at least one or more of 4.1±0.5 or 18.6±0.5 min; or
when the Kochia extract is a Kochia leaf extract, characteristic peaks include at least one or more of 4.1±0.5 or 18.6±0.5 min.

Yet another aspect provided herein is a method of detecting a Kochia extract, the method comprising detecting a Kochia extract by high performance liquid chromatography at conditions comprising:
column: C18
mobile phase gradient elution conditions:

| | | 0.01-1.0% Acid |
|---|---|---|
| Time (min) | Acetonitrile % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

wherein the conditions comprise at least one of the following:
(i) the acid aqueous solution comprises an acid selected from phosphoric acid, acetic acid, formic acid, trifluoroacetic acid, and mixtures thereof;
(ii) a concentration of the aqueous acid solution is 0.01˜0.2%;
(iii) column temperature: 30-40° C.;
(iv) detection wavelength: 355±5 nm; or
(iv) flow rate: 0.5˜1.2 mL/min.

### BRIEF DESCRIPTION OF THE DRAWINGS

FIG. 1 shows the liquid chromatogram of methanol ultrasonic extract of Kochia fruit.

FIG. 2 shows the liquid chromatogram of ethyl acetate ultrasonic extract of Kochia fruit.

FIG. 3 shows the liquid chromatogram of water ultrasonic extract of Kochia fruit.

FIG. 4 shows the liquid chromatogram of water heating reflux extract of Kochia fruit.

FIG. 5 shows the liquid chromatogram of water percolation extract of Kochia fruit.

FIG. 6 shows the liquid chromatogram of 10% ethanol ultrasonic extract of Kochia fruit.

FIG. 7 shows the liquid chromatogram of 20% ethanol ultrasonic extract of Kochia fruit.

FIG. 8 shows the liquid chromatogram of 30% ethanol ultrasonic extract of Kochia fruit.

FIG. 9 shows the liquid chromatogram of 40% ethanol ultrasonic extract of Kochia fruit.

FIG. 10 shows the liquid chromatogram of 50% ethanol ultrasonic extract of Kochia fruit.

FIG. 11 shows the liquid chromatogram of 60% ethanol ultrasonic extract of Kochia fruit.

FIG. 12 shows the liquid chromatogram of 70% ethanol ultrasonic extract of Kochia fruit.

FIG. 13 shows the liquid chromatogram of 80% ethanol ultrasonic extract of Kochia fruit.

FIG. 14 shows the liquid chromatogram of 90% ethanol ultrasonic extract of Kochia fruit.

FIG. 15 shows the liquid chromatogram of 100% ethanol ultrasonic extract of Kochia fruit.

FIG. 16 shows the overlay of liquid phase chromatograms and characteristic peaks of each extraction method provided in FIGS. 1-15.

FIG. 17 shows the liquid chromatogram of 20% ethanol ultrasonic extract of Kochia root.

FIG. 18 shows the liquid chromatogram of 20% ethanol ultrasonic extract of Kochia stem.

FIG. 19 shows the liquid chromatogram of 20% ethanol ultrasonic extract of Kochia leaves.

### DETAILED DESCRIPTION

All percentages are by weight of the total weight of the composition unless expressed otherwise.

Similarly, all ratios are by weight unless expressed otherwise. When reference is made to the pH, values correspond to pH measured at 25° C. with standard equipment. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used herein and in the appended claims, the singular form of a word includes the plural, unless the context clearly dictates otherwise. Thus, the references “a,” “an” and “the” are generally inclusive of the plurals of the respective terms. For example, reference to “an ingredient” or “a method” includes a plurality of such “ingredients” or “methods.” The term “and/or” used in the context of “X and/or Y” should be interpreted as “X,” or “Y,” or “X and Y. Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

The present disclosure provides methods of extracting Kochia under certain conditions to obtain Kochia extracts, compositions comprising the Kochia extracts, and methods of using such compositions.

One aspect of the present disclosure provides methods of obtaining the Kohchia extract.

The Kochia extract provided herein is extracted from one, two or more than two parts of the Chenopodiaceae plant Kochia scoparia (L.) Schrad, and the parts include roots, stems, leaves, flowers, and fruits.

The extract provided herein is an extract by water and/or an organic solvent.

The organic solvent used herein may include one or more of alcohol solvents, ester solvents, ketone solvents, or petroleum ether.

“Alcohol” is a compound in which one or more hydrogen atoms in the side chains of aliphatic hydrocarbons, alicyclic hydrocarbons or aromatic hydrocarbons is/are replaced by one or more hydroxyl groups. Alcohols are widely used as solvents and are cheap. The “alcoholic solvent” used herein generally are alcohols with less than twelve carbons, including but not limited to ethanol or hydrous ethanol, methanol or hydrous methanol, n-butanol or hydrous n-butanol.

“Ester” refers to a class of organic compounds formed by the reaction of acids (carboxylic acids or inorganic oxyacids) and alcohols. The “ester solvents” used herein refer to lower esters in a liquid state, including but not limited to acetic acid ethyl ester, methyl acetate.

A “ketone” is a compound in which a carbonyl group is attached to two hydrocarbon groups. The “ketone solvent” in the present invention is selected from lower ketones in liquid state, including but not limited to acetone.

The ethanol content in the hydrous ethanol used herein may be about 5-95% v/v, preferably, about 10-95% v/v. For example, the ethanol content in the hydrous ethanol can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90% or about 95% v/v. In some embodiments, the ethanol content in the hydrous ethanol is 5%, 10%, 15%, 20%, 25%, 30%, 35%, 40%, 45%, 50%, 55%, 60%, 65%, 70%, 75%, 80%, 85%, 90% or 95% v/v.

The methanol content in the aqueous methanol used herein may be about 5-95% v/v, preferably about 10-95% v/v. For example, the methanol content in the aqueous methanol can be about 5%, about 10%, about 15%, about 20%, about 25%, about 30%, about 35%, about 40%, about 45%, about 50%, about 55%, about 60%, about 65%, about 70%, about 75%, about 80% %, about 85%, about 90% or about 95% v/v. In some embodiments, the methanol content in the aqueous methanol is 5%, 10%, 15%, 20%, 25%, 30%, 35%, 40%, 45%, 50%, 55%, 60%, 65%, 70%, 75%, 80%, 85%, 90% or 95% v/v.

To obtain the Kohchia extract from the plant, a suitable plant extraction method, such as heating extraction, percolation extraction, ultrasonic extraction, microwave extraction, dipping extraction, supercritical extraction and the like can be used.

After extraction, one or more other preparation steps, such as filtration, concentration, centrifugation, drying, evaporation, and/or the like can be included.

In order to extract as much bioactive components in Kochia as possible, the Kochia can be crushed and sieved before the extraction step.

During extraction, the liquid-to-solid ratio of the added solvent to Kochia is about (6˜10):1 (v/v), for example, about 6:1, about 6.5:1, about 7:1, about 7.5:1, about 8:1, or about 8.5:1. In some embodiments, the liquid-to-solid ratio of the added solvent to Kochia is 6:1, 6.5:1, 7:1, 7.5:1, 8:1, or 8.5:1.

In some embodiments, the Kochia extract is obtained by heating extraction, for example, by heating leaching or heating reflux. In some embodiments, the extraction temperature is about 40° C.-95° C., for example, about 40° C., about 45° C., about 50° C., about 55° C., about 60° C., about 65° C., about 70° C., about 75° C., about 80° C., about 85° C., about 90° C., or about 95° C. In some embodiments, the extraction temperature is 40° C., 45° C., 50° C., 55° C., 60° C., 65° C., 70° C., 75° C., 80° C., 85° C., 90° C., or 95° C.

The number of repeated extractions is selected according to the needs, generally 1 to 4 times, preferably 2 or 3 times.

In addition, suitable extraction conditions of extraction methods such as ultrasonic extraction, microwave extraction, and supercritical extraction can be determined accordingly.

The Kochia extracts provided herein have characteristic peaks in the high-performance liquid chromatogram. For example, in the chromatogram of the Kochia fruit extract, the characteristic peaks include at least one or more of 4.1±0.5 min (characteristic peak 1), 18.6±0.5 min (characteristic peak 2), 25.4±0.5 min (characteristic peak 3); in the chromatogram of the Kochia root extract, the characteristic peak includes at least 4.1±0.5 min; in the chromatogram of the Kochia stem extract, the characteristic peaks include at least one or more of 4.1±0.5 min, 18.6±0.5 min; in the chromatogram of the Kochia leaf extract, the characteristic peaks include at least one or more of 4.1±0.5 min, 18.6±0.5 min, at the following chromatographic detection conditions:
Chromatograph: Agilent 1260
Chromatographic column: Agilent Eclipse Plus C18, (46×250 mm, 5 μm)
Column temperature: 35° C.
Detection wavelength: 355 nm;
Injection volume: 10 μL;
Flow rate: 0.8 mL/min;
Mobile phase gradient elution conditions (Table 1):

| | | 0.05% phosphoric |
|---|---|---|
| Time (min) | Acetonitrile % | acid water % |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

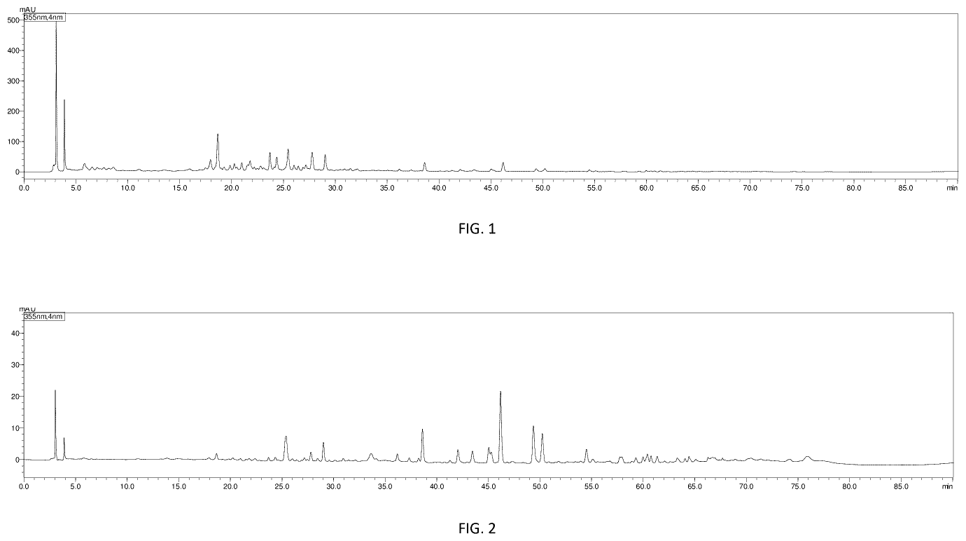

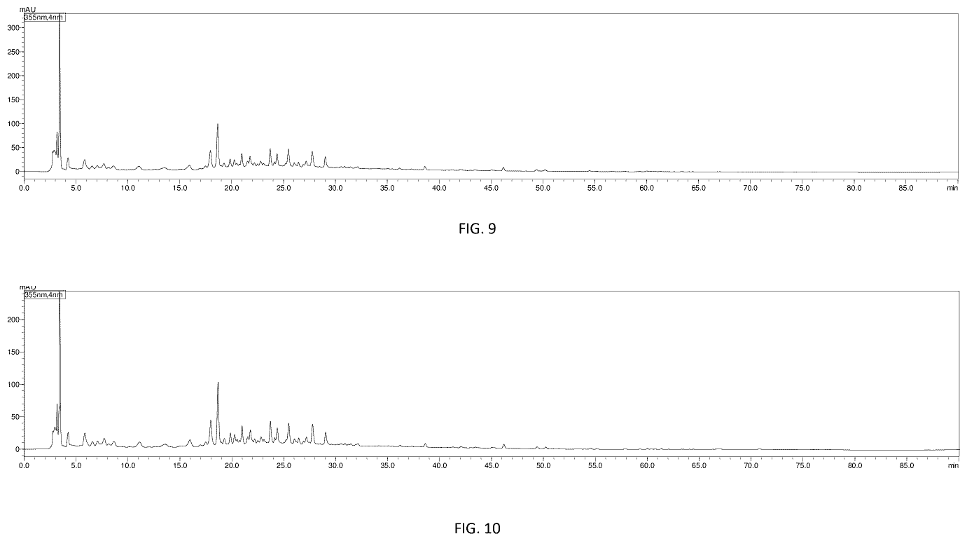

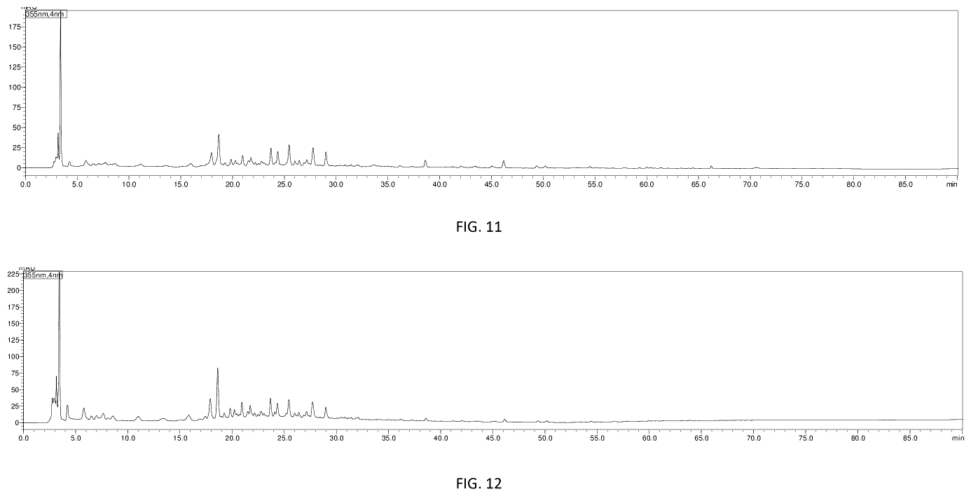

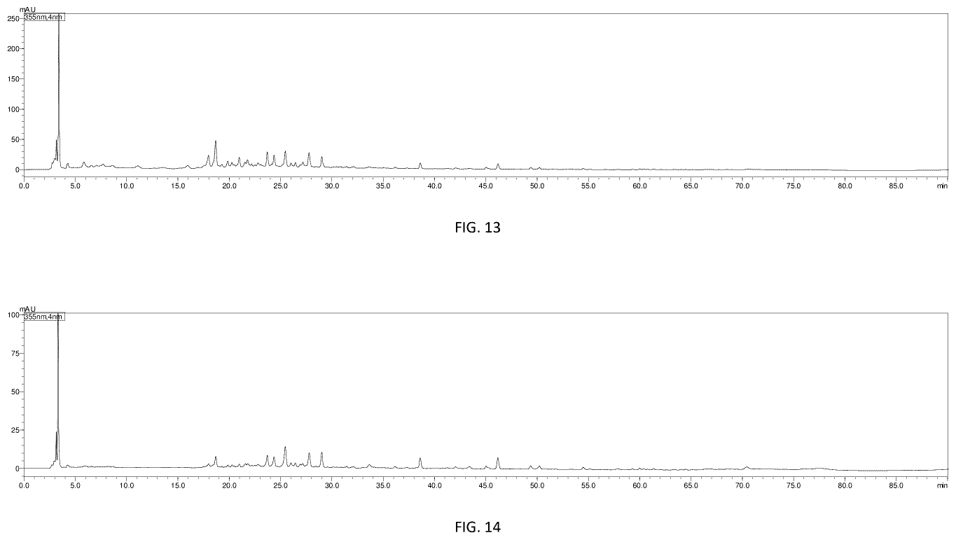

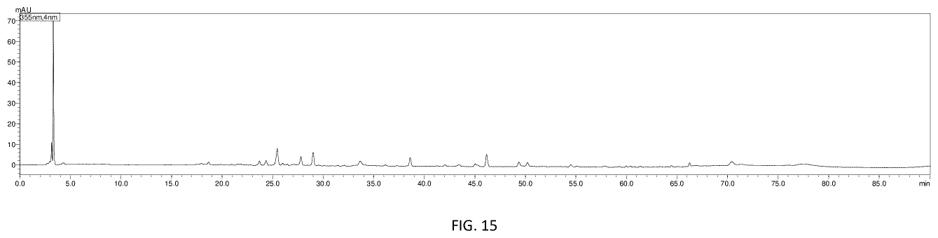

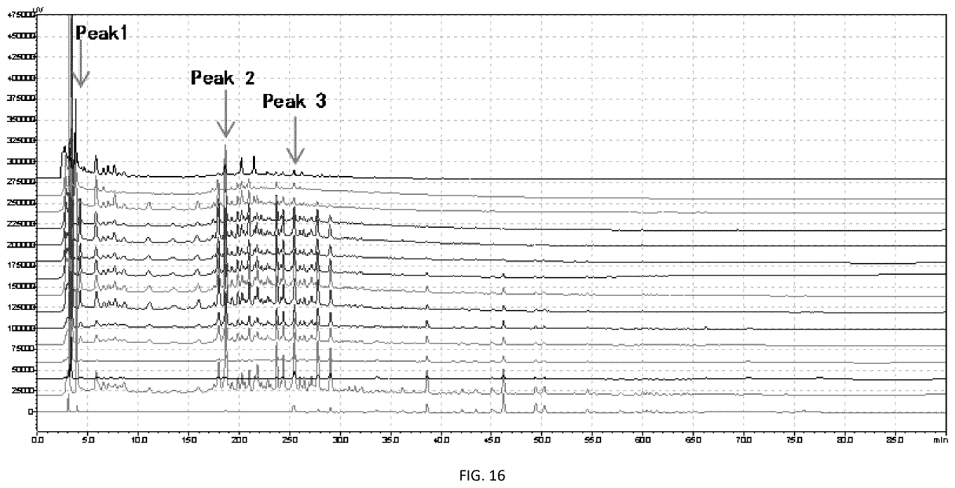

FIGS. 1-19 show the liquid chromatograms of the above-mentioned extracts. A chromatogram having any of the characteristic peaks as provided herein can be considered as the corresponding extracts provided herein.

Additionally or alternatively, a chromatogram with a similarity of at least 85%, preferably at least 90%, to the corresponding chromatogram of each extract provided herein can be considered as the corresponding extracts provided herein.

The similarity of an active ingredient of a plant extract (a phytomedicine extract) can be determined through the “Similarity Evaluation System for Chromatographic Fingerprint of Traditional Chinese Medicine” formulated by the Chinese Pharmacopoeia Commission.

Traditional Chinese medicine fingerprints is an important means of characterizing the relationship between complex components of traditional Chinese medicine and their quality.

Currently, commonly used similarity evaluation methods include: peak overlap rate method (Nei coefficient method), correlation coefficient method, distance coefficient method, Vector angle cosine method, and shared peak intensity combination method (improved Nei coefficient method), etc.

Among them, the angle cosine method treats each chromatographic fingerprint as a set of peak height (peak area) values at the corresponding retention time. This set of values can be regarded as vectors in multi-dimensional space, so that the problem of similarity between two fingerprints is transformed into the problem of similarity of two vectors in multi-dimensional space, and the cosine value is used to quantitatively characterize the similarity of fingerprints. The closer the value is to 1, the more similar the two vectors are. The angle cosine method is less affected by fluctuations in the fingerprint spectrum.

After inputting the fingerprint of each sample into the system, a standard fingerprint is used as a benchmark to perform peak matching on the input sample. The matching method can be selected from two methods: marked peak matching and full spectrum peak matching. Marked peak matching only processes marked peaks, and full spectrum Peak matching processes all peaks according to the time window, but has limited processing of tagged peaks.

After marking the common peaks, the reference peak area of 1 is used to calculate the ratio of each common fingerprint peak area to the reference peak area. For shared peaks with a single peak area accounting for ≥20% of the total peak area, the upper and lower deviation does not exceed 20%. For shared peaks with a single peak area accounting for 10%-20% of the total peak area, the peak area ratio is not required, but the relative keep time calibration is required. The output form of the result is two fingerprints marked with shared peaks, and the similarity between the two (i.e., the cosine value of the angle). The closer the value is to 1, the higher the similarity. It is generally considered that a similarity of between 0.9-1 indicates the same substance.

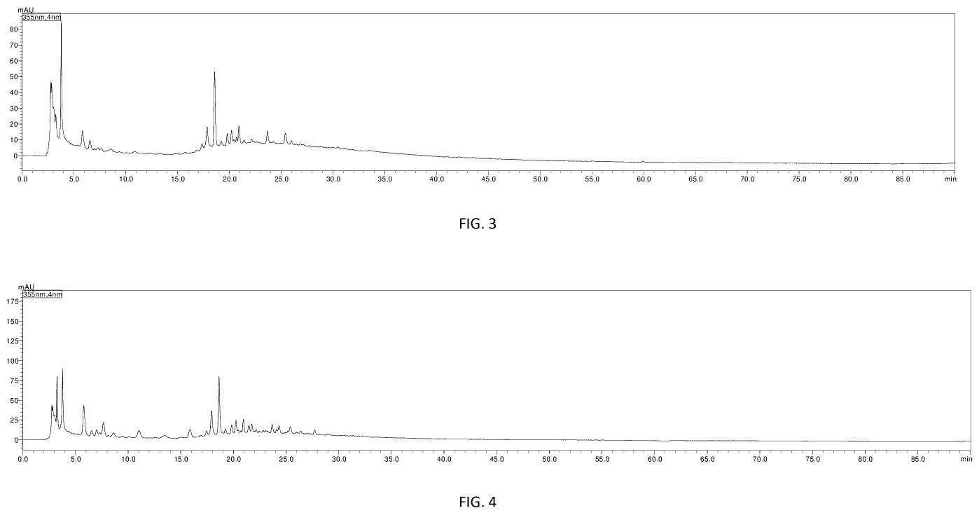

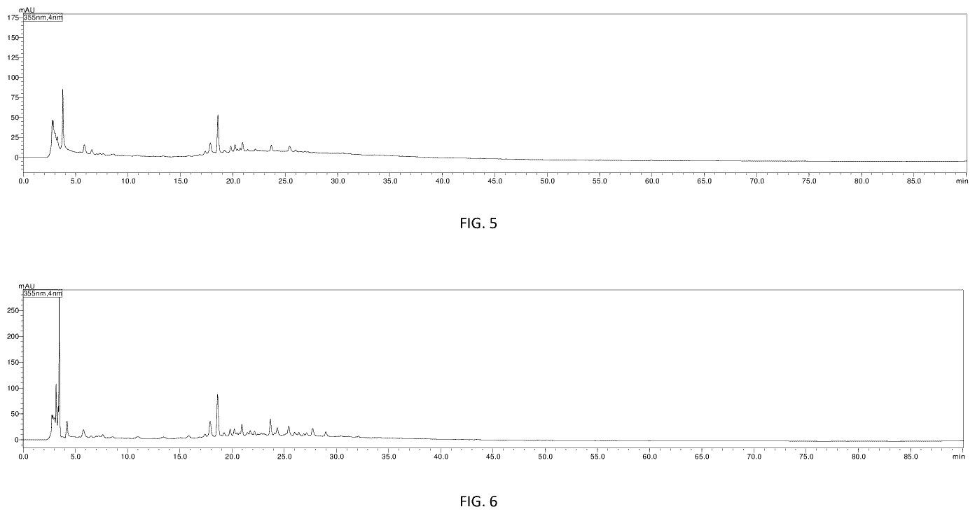

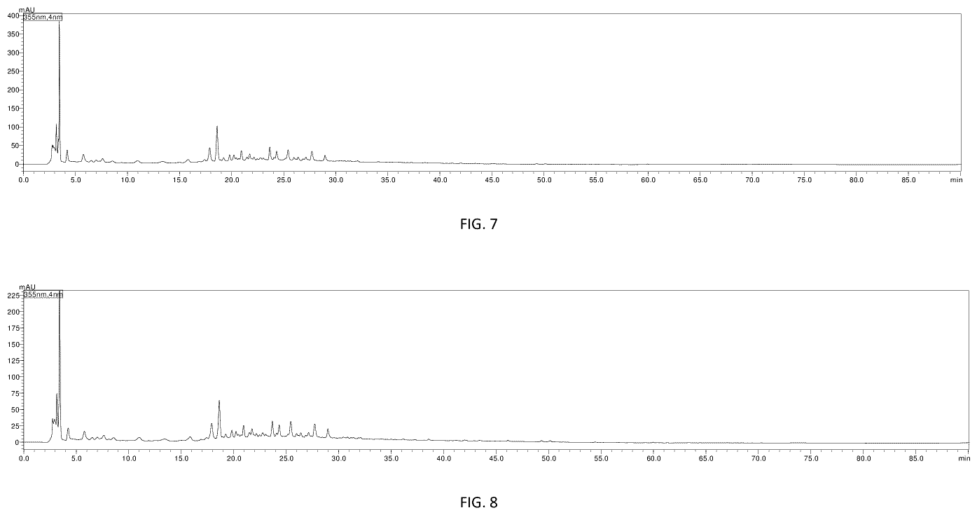

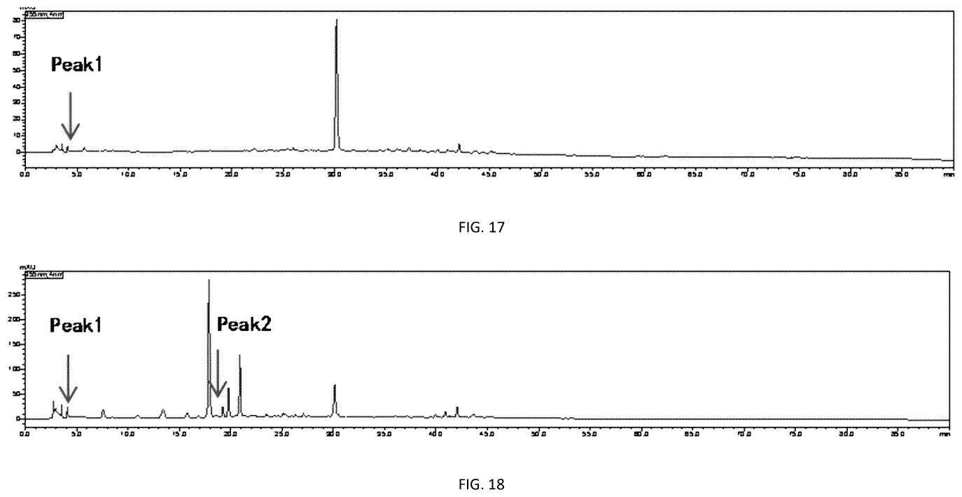

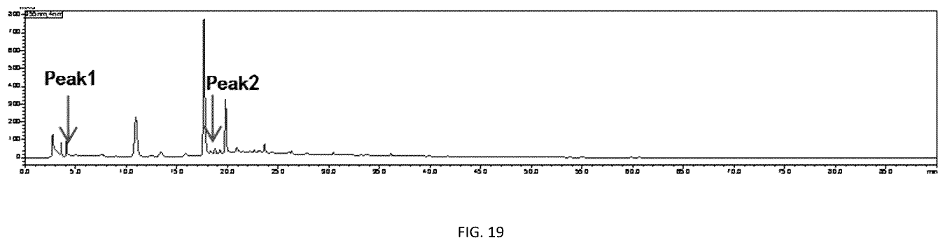

The liquid chromatograms of the Kochia fruit aqueous extracts are shown in any one of FIGS. 3-5. The liquid chromatograms of the Kochia fruit 10-100% ethanol extracts are shown in FIGS. 6-15. The liquid chromatogram of the Kochia fruit methanol extract is shown in FIG. 1. The liquid chromatogram of the Kochia fruit ethyl acetate extract is shown in FIG. 2. The liquid chromatogram of the Kochia root extract is shown in FIG. 17. The liquid chromatogram of the Kochia stem extract is shown in FIG. 18. The liquid chromatogram of Kochia leaf extract is shown in FIG. 19.

One aspect of the present disclosure provides methods of using Kochia extracts or methods of promoting plant growth by using Kochia extracts.

For example, a method of promoting plant growth is provided herein, and the method comprises treating a plant with a composition comprising Kochia extract.

In some embodiments, the Kochia extract comprises an extract from a part of a Kochia scoparia (L.) Schrad plant, and the part is selected from the group of root, stem, leaf, fruit, and mixtures thereof. In some embodiments, the part is fruit.

In some embodiments, the composition comprises the Kochia extract in a concentration of about 0.01˜about 200 ppm or 0.01˜200 ppm. In some embodiment, the composition comprises the Kochia extract in a concentration of about 0.2˜about 20 ppm or 0.2˜20 ppm.

In some embodiments, the method further comprises treating the plant with another composition selected from the group consisting of foliar fertilizers, water-soluble fertilizers, compound fertilizers, pesticides, and mixtures thereof.

In some embodiments, the promoting plant growth is selected from the group consisting of promoting seed germination; promoting growth of one or more of roots, stems, leaves or flowers and fruits; and combinations thereof.

In some embodiments, the plant is selected from the group consisting of tobacco leaves, corn, lettuce, wheat, capsicum, Chinese cabbage, lettuce, Brassica chinensis, tomato, citrus, kiwi, cherry, pear, apple, and combinations thereof.

In some embodiments, the treating the plant is selected from the group consisting of soaking a seed of the plant, spraying a leaf of the plant, irrigating a root of the plant, and combinations thereof.

In some embodiments, the Kochia extract or a composition comprising a Kochia extract provided herein is tested by high performance liquid chromatography at conditions comprising:
column: C18
mobile phase gradient elution conditions:

| | | 0.01-1.0% Acid |
|---|---|---|
| Time (min) | Acetonitrile % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

the acid aqueous solution comprises an acid selected from phosphoric acid, acetic acid, formic acid, trifluoroacetic acid, and mixtures thereof,
a concentration of the aqueous acid solution is 0.01˜0.2%,
column temperature: 30-40° C., and
detection wavelength: 355±5 nm, and flow rate: 0.5˜1.2 mL/min;
   and the obtained chromatogram has at least one of the following: when the Kochia extract is a Kochia fruit extract, characteristic peaks include one or more of 4.1±0.5 min, 18.6±0.5 min, or 25.4±0.5 min; when the Kochia extract is a Kochia root extract, characteristic peaks include at least 4.1±0.5 min; when the Kochia extract is a Kochia stem extract, characteristic peaks include at least one or more of 4.1±0.5 or 18.6±0.5 min; or when the Kochia extract is a Kochia leaf extract, characteristic peaks include at least one or more of 4.1±0.5 or 18.6±0.5 min.

It was surprisingly found that Kochia extract is a natural plant growth promoter and has a remarkable effect of promoting plant growth. This finding expands the application of Kochia extract and provides new ways of regulating plant growth in agriculture. The present disclosure provides methods of using Kochia extracts, for example, in promoting plant growth and methods of promoting plant growth by applying Kochia extracts to plants.

Promoting plant growth provided herein includes promoting plant germination, and promoting the growth of one or more of roots, stems, leaves, flowers or fruits. Some examples include promoting the growth or increase of root length, stem thickness, plant height, leaf width, leaf length, leaf number, leaf area, biomass, chlorophyll content, yield and so on.

The growth promoter provided herein refers to a plant growth promoter, or a bioactive substance that can promote cell division, differentiation and elongation, or promote the growth of plant vegetative organs and the development of plant reproductive organs.

The seed treatment is to mix the single dose of the Kochia extract or the prepared agricultural product comprising the Kochia extract with the seeds so that the surface of the seeds adheres to or absorbs the Kochia extract.

The plants include but are not limited to economic crops and food crops, such as tobacco, corn, lettuce, wheat, pepper, Chinese cabbage, Brassica chinensis L., tomato, citrus, kiwi, cherry, pear, apple, etc.

The “economic crops” are of various types, including but not limited to fiber crops (such as cotton, hemp, etc.), oil crops (such as sesame, peanuts, etc.), sugar crops (such as sugar cane, sugar beets, etc.), hobby crops (tobacco), medicinal crops, dye crops, ornamental crops, fruits (such as citrus, kiwi, cherry, pear, apple, etc.), and other economic crops (such as lettuce, pepper, cabbage, Shanghai green), etc.

The “food crops” include but are not limited to cereal crops (wheat, rice, corn), tuber crops (including sweet potatoes, potatoes, etc.) and bean crops (including soybeans, broad beans, peas, mung beans, etc.).

One aspect of the present disclosure provides compositions comprising Kochia extracts.

For example, provided herein is a composition comprising Kochia extract.

In some embodiments, the Kochia extract comprises an extract from a part of a Kochia scoparia (L.) Schrad plant, and the part is selected from the group of root, stem, leaf, fruit, and mixtures thereof. In some embodiments, the part is fruit.

In some embodiments, the composition is in a form selected from the group consisting of cream, suspension, powder, granule, and solution.

In some embodiments, the Kochia extract is an extract of water and/or an organic solvent.

In some embodiments, the organic solvent is selected from the group consisting of alcohol, ester, ketone, sherwood oil, and mixtures thereof.

In some embodiments, the alcohol is selected from the group consisting of ethanol, hydrous ethanol, methanol hydrous methanol, n-butanol, hydrous n-butanol, and mixtures thereof; the ester is selected from the group consisting of ethyl acetate, methyl acetate, and mixtures thereof; and the ketone comprises acetone.

In some embodiments, the composition further comprises a material selected from the group consisting of dispersants, wetting agents, binders, emulsifying agents, stabilizers, solvents, and mixtures thereof.

In some embodiments, the composition further comprises a component selected from the group consisting of foliar fertilizers, water-soluble fertilizers, compound fertilizers, pesticides, and mixtures thereof.

In some embodiments, the composition comprises the Kochia extract in a concentration of about 0.01˜about 200 ppm or 0.01˜200 ppm.

The Kohchia extract provided herein may preferably be the Kochia fruit extract.

The Kochia extract provided herein can be used as the active ingredient of a growth promoter, alone or in combination with other products.

The Kochia extract can be directly used as a single dose. The “single dose” refers to a product that includes the Kochia extract as the only active ingredient and does not include other auxiliary materials.

For stability and convenience of transportation and storage, the compositions provided herein may be in the forms of agricultural products. The compositions can comprise auxiliary materials and be made in different dosage forms. The auxiliary materials can be dispersants, wetting agents, binders, emulsifying agents, stabilizers, and/or solvents, etc.

The Kochia extracts provided herein can be used as a synergistic component in combination with foliar fertilizers, water-soluble fertilizers, compound fertilizers, pesticides and/or other products.

The agricultural products comprising the Kochia extracts provided herein can be in a form including but not limited to cream, suspension agent, wettable powder, powder, granule, aqueous solution, mother solution or mother powder.

The cream provided herein is a pesticide preparation, which is a liquid made by dissolving a relatively high concentration of the active ingredient(s) in a solvent and adding an emulsifier.

Generally, a cream is diluted with a large amount of water to form a stable emulsion, and then the emulsion can be spread with a sprayer. The emulsion can be sprayed in a low volume or even an ultra-low volume. The cream can be used directly or diluted with water and sprayed on crops.

Wettable powder is a very fine dry agent obtained by mixing and pulverizing the original drug, filler(s), surfactant(s) and other additives.

Suspension agent refers to the preparation comprising solid original drug with particle sizes of below 4 microns uniformly dispersed in water, with the international code of SC. The particle size is fine, generally 0.1-3 m, and the suspension rate is high. Suspension agents include water suspension agents and oil suspension agents. Water-suspension agents use water as the suspending medium, while oil-suspension agents use oil as the suspending medium without water. Commonly used oils are vegetable oils, such as corn oil and rapeseed oil. Suspension agents may contain no organic solvent at all and is a good form for processing solid materials. Suspension agents are mixtures of solid powder and liquid suspended in water and need to be shaken well before use, then diluted with water and sprayed on the crops. The suspension agents are easy to transport and dilute and can be evenly sprayed on the crops, with good adhesion and long-lasting effect.

Powder refers to the powder of the active ingredient(s), with optional diluent(s). A powder can be directly sprayed on the crops with a simple duster, with high efficiency, low crop adhesion, less residue, and less drug damage.

Granules are a solid form obtained by mixing and granulating the active ingredient(s) with auxiliary agents such as carriers, adhesives, dispersants, wetting agents, and/or stabilizers.

Granules are usually defined by their fineness, uniformity, storage stability, hardness, and/or disintegration, etc. Granules are the largest particle size among solid forms, with a diameter of 300˜1700 um. They have the advantages of simple use, small outward diffusion and long-lasting effect.

In an aqueous solution, the active ingredient is uniformly dispersed in water in the form of ions or molecules. The concentration of the active ingredient depends on the water solubility of the active ingredient, usually at the maximum solubility, and the aqueous solution can be diluted with water before use.

Mother solution or mother powder is a semi-finished product processed from the active ingredient, which needs to be further processed to prepare the final product.

The single dose of Kochia extract or the agricultural product comprising Kochia extract can be used for treating seeds, spraying foliage or root application.

When the Kochia extracts or compositions comprising Kochia extracts are formulated into a solution for promoting seed germination or plant growth, the concentration of the Kochia extract in the solution can be selected according to actual needs.

In some embodiments, the concentration of the Kochia extract can be about 0.01˜about 200 ppm or 0.01˜200 ppm, about 0.01˜about 100 ppm or 0.01˜100 ppm, about 0.01˜about 50 ppm or 0.01˜50 ppm, about 0.01 ppm, about 0.02 ppm, about 0.03 ppm, about 0.1 ppm, about 0.2 ppm, about 0.3 ppm, about 1.0 ppm, about 2.0 ppm, about 3.0 ppm, about 10 ppm, about 20 ppm, about 30 ppm, or about any concentration within about 0.01˜about 200 ppm or 0.01˜200 ppm. In some embodiments, the concentration of Kochia extract is 0.01 ppm, 0.02 ppm, 0.03 ppm, 0.1 ppm, 0.2 ppm, 0.3 ppm, 1.0 ppm, 2.0 ppm, 3.0 ppm, 10 ppm, 20 ppm, or 30 ppm, or any concentration within about 0.01˜about 200 ppm or 0.01˜200 ppm. In some embodiments, a preferred concentration of the Kochia extract is about 0.02˜about 20 ppm, 0.02˜20 ppm, any subrange or concentration within about 0.02˜about 20 ppm, or any subrange or concentration within 0.02˜20 ppm.

One aspect of the present disclosure is a method of detecting Kochia extract by high performance liquid chromatography at the following conditions:
Column: C18
Mobile phase gradient elution conditions (Table 2):

| | | 0.01-1.0% Acid |
|---|---|---|
| Time (min) | Acetonitrile % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

In some embodiments, the acid aqueous solution used herein includes but is not limited to phosphoric acid, acetic acid, formic acid, and trifluoroacetic acid.

In some embodiments, the concentration of the aqueous acid solution used herein can be about 0.01-0.2%, for example, about 0.01%, about 0.05%, about 0.1%, about 0.15%, or about 0.2%. In some embodiments, the concentration of the aqueous acid solution used herein is 0.01%, 0.05%, 0.1%, 0.15%, or 0.2%. All these percentages are v/v percentages.

In some embodiments, the chromatographic conditions also include one of the following: column temperature: 30-40° C.; detection wavelength: 355±5 nm; and/or flow rate: 0.5˜1.2 mL/min.

In some embodiments, when the Kochia extract is a Kochia fruit extract, and characteristic peaks include one or more of 4.1±0.5 min, 18.6±0.5 min, or 25.4±0.5 min. In some embodiments, when the Kochia extract is a Kochia root extract, characteristic peaks include at least 4.1±0.5 min. In some embodiments, when the Kochia extract is a Kochia stem extract, characteristic peaks include at least one or more of 4.1±0.5 or 18.6±0.5 min. In some embodiments, when the Kochia extract is a Kochia leaf extract, characteristic peaks include at least one or more of 4.1±0.5 or 18.6±0.5 min.

The detection methods provided herein can detect more chromatographic peaks of the Kochia extract than other methods, and can find common characteristic peaks in various Kochia extracts, which provides possibility for quality control of the Kochia extracts.

### EXAMPLES

The Examples are non-limiting and only for illustration. Based on the embodiments disclosed herein, all other embodiments obtained by those skilled in the art without creative efforts fall within the protection scope of the present disclosure. It should be pointed out that, if there are any processes in the following that are not specifically described in detail, those skilled in the art can realize or understand. The reagents or instruments used were regarded as conventional products that can be purchased from the market.

The Kochia fruit used in the following examples is the dried mature fruit of the Chenopodiaceae plant Kochia.

### Example 1: Preparation of Kochia Fruit Extract

Kochia dry fruit was ground and sieved with 80 meshes for later use.
1) 95% ethanol extraction: A certain amount of Kochia dry fruit was provided, 8 times of the volume of 95% ethanol was added, and the mixture was heated to about 85° C. and refluxed for about 2 hours. These steps were repeated twice. The filtrates were combined and concentrated under reduced pressure to a weight ratio of 1:1 (that is, 1 g of Kochia dry fruit corresponds to 1 g of the concentrated extract) to obtain a concentrated ethanol extract of Kochia fruit, which was then used for activity testing.
2) Water extraction: A certain amount of Kochia dry fruit was provided, 8 times of the volume of water was added, and the mixture was heated to about 90° C. and refluxed for about 2 hours. These steps were repeated twice. The filtrates were combined and concentrated under reduced pressure to a weight ratio of 1:1 (that is, 1 g of Kochia dry fruit corresponds to 1 g of the concentrated extract) to obtain a concentrated water extract of Kochia fruit, which was then used for activity test.
3) Ethyl acetate extraction: A certain amount of Kochia dry fruit was provided, 8 times of the volume of ethyl acetate was added, and the mixture was heated to about 85° C. and refluxed for about 2 hours. These steps were repeated twice. The filtrates were combined and concentrated under reduced pressure to a weight ratio of 1:1 (That is, 1 g of Kochia dry fruit corresponds to 1 g of the concentrated extract) to obtain a concentrated ethyl acetate extract of Kochia fruit, which was then used for activity testing.

### Example 2: Liquid Chromatograms of Different Extraction Processes

### 1) Different Water Extraction Processes

A. Ultrasonic extraction: A certain amount of Kochia dry fruit was provided, 8 times of the volume of water was added, and the mixture was ultrasonicated at room temperature for about 30 minutes. These steps were repeated twice, and the filtrates were combined. A sample of the combined filtrates was filtered through a 0.45 μm filter membrane and then entered the liquid phase for detection.

B: Heating and reflux: A certain amount of Kochia dry fruit was provided, 8 times of the volume of water was added, and the mixture was heated to about 90° C. and refluxed for about 2 hours. These steps were repeated twice, and the filtrates were combined. A sample of the combined filtrates was filtered through a 0.45 μm filter membrane and entered the liquid phase for detection.

C: Diafiltration: A certain amount of Kochia dry fruit was provided, 10 times of the volume of water at 50° C. was added, and diafiltration extraction of the mixture was carried out at a speed of about 2 mL/min. A sample of the obtained extracted mixture was filtered through a 0.45 μm filter membrane and entered the liquid phase for detection.

### 2) Different Ethanol Extraction Processes

A certain amount of Kochia dry fruit was provided, and 8 times of the volume of ethanol was added. The ethanol concentration was 10%, 20%, 30%, 40%, 50%, 60%, 70%, 80%, 90% or 100% respectively. All these percentages are v/v percentages. The mixture was ultrasonicated at room temperature for 30 minutes. These steps were repeated twice, and the filtrates were combined. A sample of the combined filtrates was filed through a 0.45 μm filter membrane and entered the liquid phase for detection.

### 3) Methanol Extraction Process

A certain amount of Kochia dry fruit was provided, 8 times of the volume of methanol was added, and the mixtures was ultrasonicated at room temperature for 30 minutes. These steps were repeated twice, and the filtrates were combined. A sample of the combined filtrates was filed through a 0.45 μm filter membrane and entered the liquid phase for detection.

### 4) Ethyl Acetate Extraction Process

A certain amount of Kochia dry fruit was provided, 8 times the volume of methanol was added, and the mixtures was ultrasonicated at room temperature for 30 minutes. These steps were repeated twice, and the filtrates were combined. A sample of the combined filtrates was through a 0.45 μm filter membrane and entered the liquid phase for detection.

### 5) Liquid Phase Testing Conditions

Chromatograph: Agilent 1260
Chromatographic column: Agilent Eclipse Plus C18, (46×250 mm, 5 m)
Column temperature: 35° C.
Detection wavelength: 355 nm;
Injection volume: 10 L;
Flow rate: 0.8 mL/min;

### Mobile Phase Gradient Elution Conditions (Table 3):

| Time (min) | Acetonitrile % | 0.05% Phosphate |
|---|---|---|
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

### 5) Liquid Chromatograms of Different Extracted Samples

The liquid chromatograms of different samples are shown in FIGS. 1-16.

### Example 3: The Growth-Promoting Effect of Different Kochia Fruit Extracts on Tobacco

Experimental samples: Kochia fruit ethanol extract, Kochia fruit water extract, Kochia fruit ethyl acetate extract. The concentrated extracts in Example 1 were prepared into a mother solution with a concentration of 1% (w/v) with pure water, namely, 1 g of the concentrated extract is diluted in 100 ml water to prepare the mother solution, which has a concentration of 10000 ppm. Then, the mother solution is diluted with water according to Table 4.

TABLE 4
Sample Concentrations

| Sample No. | Treatment | Concentrations (ppm) |
|---|---|---|
| 1 | Kochia fruit ethanol extract | 0.02 |
| 2 | | 0.2 |
| 3 | | 2 |
| 4 | Kochia fruit water extract | 0.02 |
| 5 | | 0.2 |
| 6 | | 2 |
| 7 | Kochia fruit ethyl acetate extract | 0.02 |
| 8 | | 0.2 |
| 9 | | 2 |
| 10 | Control (water only) | — |

After the samples were prepared according to Table 4, the leaves of the tobacco seedlings were evenly sprayed by the samples. Each sample was sprayed onto 6 plants. Each sample was sprayed in an amount that ensured the sample did not drip onto the soil to prevent any sample entering the soil from affecting the experimental results. The plants were cultured at a temperature of 28° C., light of 2000 lux for 14 h/10 h (day/night), and humidity of 65%. The plant phenotype analysis system was used to record the tobacco leaf area (mm²) before and 5 days after the treatment, and the leaf area growth rate was calculated to evaluate the growth-promoting effect of each sample.

### The Leaf Area Growth Rate Calculation Formula is as Follows:

Leaf area growth rate (%)=(final leaf area−initial leaf area)×100/initial leaf area

The growth rates of leaf area of different treatment groups after 7 days of samples spaying are shown in Table 5. The results show that within the concentration range of 0.02-2 ppm, the Kochia fruit extracts by different solvents clearly have promoting effects on tobacco. The best growth-promoting concentration of the Kochia fruit ethanol extract, water extract and ethyl acetate extract is 0.2 ppm.

TABLE 5
The Results Of The Growth-Promoting Effect Of
Different Kochia Fruit Extracts On Tobacco

| | Extract | 7-day Leaf Area |
|---|---|---|
| | Concentration | Growth Rate |
| Treatment | (ppm) | (%) |
| Kochia fruit ethanol | 0.2 | 872.56 |
| extract | 2 | 752.54 |
| | 20 | 672.98 |
| Kochia fruit water | 0.2 | 811.01 |
| extract | 2 | 711.96 |
| | 20 | 671.87 |
| Kochia fruit ethyl | 0.2 | 845.42 |
| acetate extract | 2 | 799.95 |
| | 20 | 701.87 |
| control (water only) | — | 579.4 |

### Example 4: The Growth-Promoting Effect of Kochia Fruit Extracts Obtained Under Different Extraction Process Conditions

Experimental samples: 15 extracts in Example 2 each were concentrated under reduced pressure to 1:1, prepared with water as mother solutions with a concentration of 1% (w/v, 1 g of concentrated extract in 100 ml pure water), and then diluted with water according to Table 6.

TABLE 6
Sample Concentrations

| No. | Treatment | Concentration (ppm) |
|---|---|---|
| 1 | 10% ethanol ultrasound extract | 0.02 |
| 2 | | 0.2 |
| 3 | | 2 |
| 4 | 20% ethanol ultrasound extract | 0.02 |
| 5 | | 0.2 |
| 6 | | 2 |
| 7 | 30% ethanol ultrasound extract | 0.02 |
| 8 | | 0.2 |
| 9 | | 2 |
| 10 | 40% ethanol ultrasound extract | 0.02 |
| 11 | | 0.2 |
| 12 | | 2 |
| 13 | 50% ethanol ultrasound extract | 0.02 |
| 14 | | 0.2 |
| 15 | | 2 |
| 16 | 60% ethanol ultrasound extract | 0.02 |
| 17 | | 0.2 |
| 18 | | 2 |
| 19 | 70% ethanol ultrasound extract | 0.02 |
| 20 | | 0.2 |
| 21 | | 2 |
| 22 | 80% ethanol ultrasound extract | 0.02 |
| 23 | | 0.2 |
| 24 | | 2 |
| 25 | 90% ethanol ultrasound extract | 0.02 |
| 26 | | 0.2 |
| 27 | | 2 |
| 28 | 100% ethanol ultrasound extract | 0.02 |
| 29 | | 0.2 |
| 30 | | 2 |
| 31 | water ultrasound extract | 0.02 |
| 32 | | 0.2 |
| 33 | | 2 |
| 34 | methanol ultrasound extract | 0.02 |
| 35 | | 0.2 |
| 36 | | 2 |
| 37 | ethyl acetate ultrasound extract | 0.02 |
| 38 | | 0.2 |
| 39 | | 2 |
| 40 | water heated reflux extract | 0.02 |
| 41 | | 0.2 |
| 42 | | 2 |
| 43 | water percolation extract | 0.02 |
| 44 | | 0.2 |
| 45 | | 2 |
| 49 | control (water only) | — |

After the treatment agent samples were prepared according to Table 6, the leaves of the tobacco seedlings were evenly sprayed by these samples. Each sample was sprayed onto 6 plants. Each sample was sprayed in an amount that ensured the sample did not drip onto the soil to prevent any sample entering the soil from affecting the experimental results. The plants were cultured under a temperature of 28° C., light of 2000 lux for 14 h/10 h (day/night), and humidity of 65%. The plant phenotype analysis system was used to record the tobacco leaf area (mm²) before and 7 days after the treatment, and the growth rate of the leaf area was calculated to evaluate the growth-promoting effect of each sample. The formula for the leaf area growth rate is as follows:

Leaf area growth rate (%)=(final leaf area−initial leaf area)×100/initial leaf area

The growth rates of leaf area of different treatment groups after 7 days of treatment are shown in Table 7. The experimental results show that that the 15 Kochia fruit extracts by different solvents and different extraction methods have a stimulating effect on tobacco within the concentration range of 0.02˜2 ppm. Among the water extracts, the samples extracted by ultrasound have better growth-promoting effects, and the optimal growth-promoting concentration is 0.2 ppm. For the ethanol extracts of different concentrations, the optimal growth-promoting concentration is 0.2 ppm, and the growth-promoting effect of 10˜30% ethanol extracts is better than that of the 40-100% ethanol extracts. For the methanol and ethyl acetate extracts, the best growth-promoting concentration is 0.2 ppm.

TABLE 7
Tobacco Growth-Promoting Effects

| | | Concentration | 7-day Leaf Area |
|---|---|---|---|
| No. | Treatment | (ppm) | Growth Rate % |
| 1 | 10% ethanol ultrasound | 0.02 | 861.60 |
| 2 | extract | 0.2 | 901.72 |
| 3 | | 2 | 729.56 |
| 4 | 20% ethanol ultrasound | 0.02 | 904.05 |
| 5 | extract | 0.2 | 937.17 |
| 6 | | 2 | 815.25 |
| 7 | 30% ethanol ultrasound | 0.02 | 804.79 |
| 8 | extract | 0.2 | 847.81 |
| 9 | | 2 | 785.86 |
| 10 | 40% ethanol ultrasound | 0.02 | 800.87 |
| 11 | extract | 0.2 | 828.74 |
| 12 | | 2 | 693.97 |
| 13 | 50% ethanol ultrasound | 0.02 | 756.22 |
| 14 | extract | 0.2 | 910.62 |
| 15 | | 2 | 801.45 |
| 16 | 60% ethanol ultrasound | 0.02 | 726.49 |
| 17 | extract | 0.2 | 857.86 |
| 18 | | 2 | 693.05 |
| 19 | 70% ethanol ultrasound | 0.02 | 759.35 |
| 20 | extract | 0.2 | 830.97 |
| 21 | | 2 | 730.68 |
| 22 | 80% ethanol ultrasound | 0.02 | 753.41 |
| 23 | extract | 0.2 | 727.45 |
| 24 | | 2 | 724.02 |
| 25 | 90% ethanol ultrasound | 0.02 | 727.42 |
| 26 | extract | 0.2 | 873.53 |
| 27 | | 2 | 742.16 |
| 28 | 100% ethanol ultrasound | 0.02 | 836.7 |
| 29 | extract | 0.2 | 827.74 |
| 30 | | 2 | 744.95 |
| 31 | water ultrasound extract | 0.02 | 807.55 |
| 32 | | 0.2 | 872.57 |
| 33 | | 2 | 757.93 |
| 34 | methanol ultrasound extract | 0.02 | 672.97 |
| 35 | | 0.2 | 806.29 |
| 36 | | 2 | 781.72 |
| 37 | ethyl acetate ultrasound | 0.02 | 820.87 |
| 38 | extract | 0.2 | 849.89 |
| 39 | | 2 | 774.14 |
| 40 | water heated reflux extract | 0.02 | 658.78 |
| 41 | | 0.2 | 831.85 |
| 42 | | 2 | 763.85 |
| 43 | water percolation extract | 0.02 | 713.95 |
| 44 | | 0.2 | 823.47 |
| 45 | | 2 | 688.03 |
| 46 | control (water only) | — | 617.07 |

### Example 5: The Growth-Promoting Test of Root Irrigation on Lettuce

Experimental sample: The water ultrasonic extract in Example 2 was prepared with water as mother solutions with a concentration of 1% (w/v, 1 g of concentrated extract in 100 ml pure water) and then diluted with water according to Table 8.

TABLE 8
Sample Concentrations

| No. | Treatment | Concentration (ppm) |
|---|---|---|
| 1 | Kochia fruit water ultrasonic extract | 0.2 |
| 2 | | 2 |
| 3 | | 20 |
| 4 | control (water only) | — |

The test crop in this experiment was lettuce, specifically, Yingxia sharp-leaved lettuce. Three concentrations were tested for each sample: 0.2, 2, and 20 ppm, respectively. Water was used as blank control. Each sample was applied to six lettuce seedlings. For each treatment, the management measures and fertilization and water conditions were the same. The lettuce seeds were raised, and the culture substrate earthworm soil, vermiculite, coir peat and perlite were provided in a ratio of 3:1:1:1. The tests were carried out when the seeds were cultivated to five leaves and one heart. 24 pots of lettuce seedlings of the same size were selected, and root irrigation treatment was carried out. The amount of root irrigation in each pot was set to 50 mL, and a total of 2 treatments were performed with an interval of 7 days. After 14 days, the shoot height, root length, shoot fresh weight, shoot dry weight and root fresh weight of the lettuce seedlings were measured and recorded. The experiment conditions were 3200 lux light for 14 hours, 25° C., 10 hours of darkness, 20° C., and a relative humidity of 65%. During the whole experiment, all treatments were managed the same.

The test results are shown in Table 9. The results show that the root irrigation treatment of lettuce seedlings by the Kochia fruit extract in the concentration range of 0.2-20 ppm can significantly improve the plant height, root length, biomass and SPAD value (Chlorophyll content index) of lettuce seedlings and the number of leaves. The growth-promoting effect was the best at a concentration of 0.2 ppm.

TABLE 9
Effects Of Treatments Of Kochia Fruit
Extract On Lettuce Growth Indicators

| | Blank | Kochia Fruit water | | |
|---|---|---|---|---|
| | (water | ultrasonic extract | | |
| | only) | 0.2 ppm | 2 ppm | 20 ppm |
| Root length (cm) | 11.04 | 17.85 | 16.90 | 15.17 |
| Root fresh weight (g) | 0.51 | 1.58 | 1.05 | 1.27 |
| Shoot height (cm) | 19.80 | 23.93 | 22.30 | 22.14 |
| Shoot fresh weight (g) | 3.03 | 6.05 | 6.00 | 5.01 |
| Shoot dry weight (g) | 0.15 | 0.40 | 0.39 | 0.28 |
| SPAD value | 18.13 | 27.85 | 24.34 | 23.32 |
| Number of leaves | 4.83 | 6.33 | 6.00 | 5.50 |

### Example 6: Seed Soaking Germination Test on Corn

Experimental sample: The Kochia fruit 20% ethanol extract in Example 2 was prepared with water as a mother solution with a concentration of 1% (w/v, 1 g of concentrated extract in 100 ml pure water) and then diluted with water according to Table 10.

TABLE 10
Sample Concentrations

| No. | Treatment | Concentration (ppm) |
|---|---|---|
| 1 | Kochia fruit 20% ethanol extract | 0.2 |
| 2 | | 2 |
| 3 | | 20 |
| 4 | control (water only) | — |

The test crop in this experiment was corn. Three concentrations of the extracts were tested: 0.2, 2 and 20 ppm, and a total of 4 treatments (including blank water control) were carried out. Some plump corn seeds were soaked in the extracts for 24 hours, and then washed with water. 15 corn seeds were placed in the culture boxes, each including 3 layers of absorbent paper at the bottom completely pre-wetted by adding 10 mL of distilled water. Each treatment was repeated 4 times.

The culture boxes were placed in an incubator with a constant temperature for germination cultivation for 6 days with 14 h light at 28° C. and 10 h darkness at 25° C. each day. During the whole experiment, 5 mL of water was added regularly at 9 am every day to keep each culture box moist. The germination potential was measured after 3 days, the shoot length and root length were measured after 6 days, and the root vitality and bud vitality indexes were calculated. The calculation formulas of germination potential, germination percentage, root vitality index and bud vitality index are as follows:

$$Germination potential ( \% ) = number of germinated seeds on the third day / total number of seeds \times 100$$

$$Germination rate ( \% ) = number of germinated seeds on the sixth day / total number of seeds \times 10 \; 0$$

$$Root viality index = number of germinated seeds on the sixth day / total number of seeds \times average root length of germinated seedlings \times 100$$

$$Bud viality index = number of germinated seeds on the sixth day / total number of seeds \times average sprout length of germinated seedlings \times 100$$

The experimental results are shown in Table 11. The results show that when corn seeds are soaked in the Kochia fruit extracts in the concentration range of 0.2˜20 ppm, the Kochia fruit extract can significantly improve the germination rate and germination potential of corn seeds and can significantly promote the growth of the above-ground and underground biomass of corn seedlings. The optimal concentration is 0.2 ppm.

TABLE 11
Effects Of Kochia Fruit Extracts On Corn Biomass

| | | Germination | Germination | Root | Bud | Root | Bud |
|---|---|---|---|---|---|---|---|
| | Concentration | potential | rate | length | length | vitality | vitality |
| Treatment | (ppm) | (%) | (%) | (cm) | (cm) | index | index |
| Kochia | 0.2 | 98.33 | 100.00 | 19.53 | 14.27 | 19.53 | 14.27 |
| fruit 20% | 2 | 93.33 | 95.00 | 19.17 | 13.72 | 18.21 | 13.03 |
| ethanol | 20 | 96.67 | 96.67 | 19.28 | 13.56 | 18.64 | 13.11 |
| extract | | | | | | | |
| control | — | 73.33 | 85.00 | 13.38 | 9.94 | 11.37 | 8.45 |
| (water | | | | | | | |
| only) | | | | | | | |

### Example 7: Seed Dressing Germination Test on Corn

Experimental sample: The Kochia fruit 20% ethanol extract in Example 2 was prepared with water as a mother solution with a concentration of 1% (w/v, 1 g of concentrated extract in 100 ml pure water) and then diluted with water according to Table 12.

TABLE 12
Sample Concentrations

| No. | Treatment | Concentration (ppm) |
|---|---|---|
| 1 | Kochia fruit 20% ethanol extract | 0.2 |
| 2 | | 2 |
| 3 | | 20 |
| 4 | control (water only) | — |

The test crop in this experiment was corn, three concentrations were tested: 0.2, 2 and 20 ppm, and a total of 4 treatments (including blank water control) were carried out. 50 g of normal 60 plump seeds and 1 g of the sample were placed in 200 mL bottle. The bottle was then capped and shaken repeatedly until each seed was evenly coated by the sample. Then, the seeds were spread out and placed in an incubator at a constant temperature (25° C.) for 24 hours to dry. After the seeds were dried, they were sealed and stored at room temperature. On the second day, 15 normal and plump seeds were placed evenly in culture boxes lined with filter paper, and 15 mL of water was added to each box to completely soak the filter paper. The boxes were placed in a constant temperature incubator for germination culture for 7 days with 14 h light at 28° C. and 10 h dark at 25° each day. During the whole test, 5 mL of water was regularly added with a pipette at 9 am every day to keep all the culture boxes moist. The germination potential was measured after 3 days, and the shoot length and root length were measured after 7 days, and the root vitality and bud vitality indexes were calculated. The calculation formulas of germination potential, germination percentage, root vitality index and bud vitality index are as follows:

$$Germination potential ( \% ) = number of germinated seeds on the third day / total number of seeds \times 100$$

$$Germination rate ( \% ) = number of germinated seeds on the seventh day / total number of seeds \times 10 \; 0$$

$$Root viality index = number of germinated seeds on the seventh day / total number of seeds \times average root length of germinated seedlings \times 100$$

$$Bud viality index = number of germinated seeds on the seventh day / total number of seeds \times average sprout length of germinated seedlings \times 100$$

The experimental results are shown in Table 13. The results show that when the Kochia fruit extract was used to dress corn seeds in the concentration range of 0.2-20 ppm, it can improve the germination rate and germination potential of corn and has a significant effect on increasing the biomass of corn seedlings. Its effect is the best at the concentration of 2 ppm.

TABLE 13
Effect Of The Kochia Fruit Extracts On Corn Biomass

| | | Germination | Germination | Root | Bud | Root | Bud |
|---|---|---|---|---|---|---|---|
| | Concentration | potential | rate | length | length | vitality | vitality |
| Treatment | (ppm) | (%) | (%) | (cm) | (cm) | index | index |
| Kochia fruit | 0.2 | 98.33 | 98.33 | 16.45 | 11.44 | 16.18 | 11.25 |
| 20% ethanol | 2 | 100.00 | 100.00 | 17.59 | 11.99 | 17.59 | 11.99 |
| | 20 | 95.00 | 95.00 | 17.091 | 11.92 | 16.24 | 11.32 |
| control | — | 91.67 | 93.33 | 12.39 | 9.54 | 11.56 | 8.90 |
| (water only) | | | | | | | |

### Example 8: Seed Dressing Germination Test on Wheat

Experimental sample: The Kochia fruit 50% ethanol extract in Example 2 was prepared with water as a mother solution with a concentration of 1% (w/v, 1 g of concentrated extract in 100 ml pure water) and then diluted with water according to Table 14.

TABLE 14
Sample Concentrations

| No. | Treatment | Concentration (ppm) |
|---|---|---|
| 1 | Kochia fruit 50% ethanol extract | 0.2 |
| 2 | | 2 |
| 3 | | 20 |
| 4 | control (water only) | — |

The test crop in this experiment was wheat, three concentrations were tested: 0.2, 2 and 20 ppm, and a total of 4 treatments (including blank water control) were carried out. 25 g of normal plump seeds and 0.5 g of the sample were placed in 200 mL bottle. The bottle was capped and shaken repeatedly until each seed was evenly coated by the sample. Then, the seeds were spread out and placed in a constant temperature incubator (25° C.) for 24 hours to dry. After the seeds were dried, they were sealed and stored at room temperature. On the second day, 15 normal and plump seeds were selected and placed evenly in culture boxes lined with filter paper, and 15 mL of water was to each box to completely soak the filter paper. The boxes were placed in a constant temperature incubator for germination culture for 7 days with 14 h light at 28° C. and 10 h darkness at 25° C. each day. During the whole test, 5 mL of water was regularly added with a pipette at 9 am every day to keep all the culture boxes moist. After 3 days, the germination potential was measured, after 7 days, the germination rate was investigated, the wheat sprout length and root length were measured, and the root vitality index and bud vitality index were calculated. Before the start of the test, the light parameters were set to 3200 lux light for 14 h at 25° C. and 10 h of darkness at 20° C., with 65% humidity. During the whole test, the management of all treatments were consistent. Other management measures and fertilizer and water conditions were kept the same during the experiment. The calculation formulas of germination potential, germination percentage, root vitality index and bud vitality index are as follows:

$$Germination potential ( \% ) = number of germinated seeds on the third day / total number of seeds \times 100$$

$$Germination rate ( \% ) = number of germinated seeds on the seventh day / total number of seeds \times 10 \; 0$$

$$Root viality index = number of germinated seeds on the seventh day / total number of seeds \times average root length of germinated seedlings \times 100$$

$$Bud viality index = number of germinated seeds on the seventh day / total number of seeds \times average sprout length of germinated seedlings \times 100$$

The experimental results are shown in Table 15. The results show that the Kochia fruit extract, when applied as seed dressing on wheat seeds in the concentration range of 0.2-20 ppm, it can improve the germination rate and germination potential of wheat and has a significant effect on increasing the biomass of wheat seedlings. The effect is the best at the concentration of 2 ppm.

TABLE 15
Effect Of The Kochia Fruit Extract On Wheat Biomass

| | | Germination | Germination | Root | Bud | Root | Bud |
|---|---|---|---|---|---|---|---|
| | Concentration | potential | rate | length | length | vitality | vitality |
| Treatment | (ppm) | (%) | (%) | (cm) | (cm) | index | index |
| Kochia | 0.2 | 91.67 | 97.33 | 10.50 | 10.55 | 10.22 | 10.27 |
| fruit 50% | 2 | 98.33 | 100.00 | 10.78 | 10.93 | 10.78 | 10.93 |
| ethanol | 20 | 96.67 | 98.32 | 10.56 | 10.79 | 10.38 | 10.61 |
| extract | | | | | | | |
| control | — | 90.33 | 95.21 | 10.11 | 10.12 | 9.63 | 9.64 |
| (water | | | | | | | |
| only) | | | | | | | |

### Example 9: The Effect of Kochia Fruit Extract Combined with Compound Fertilizer on the Growth of Pepper in Greenhouses

Experimental sample: The Kochia fruit 100% ethanol extract in Example 2 was prepared with water as a mother solution with a concentration of 1% (w/v, 1 g of concentrated extract in 100 ml pure water) and then diluted with water according to Table 16.

TABLE 16
Sample Concentrations

| No. | Treatment | Concentration (ppm) |
|---|---|---|
| 1 | Kochia fruit 100% ethanol extract | 0.2 |
| 2 | | 2 |
| 3 | control (water only) | — |

The test crop was pepper at the seedling stage. Three plots of the field were tested for each treatment, with a total of 150 capsicum plants in the three plots. 15 peppers with the same growth pattern were selected in each plot for tracking. 150 ml of the sample was applied to each plant, and an organic carbon compound fertilizer was used as the base fertilizer (N+P+K≥10 wt %, organic Carbon≥30 wt %). The greenhouse operation in the later stage was carried out according to the habits of farmers. The plants were tracked and investigated before and 15 days and 30 days after the treatment. The flowering quantity and fruit setting were investigated at the flowering and fruiting period of 45 days after the treatment.

$$Phsiological index growth rate ( \% ) = ( phsiological index after treatment - physiological index before treatment ) \times 100 / physiological index before treatment$$

The results in Tables 17-19 show that the Kochia fruit 100% ethanol extract of 0.2 to 2 ppm can significantly promote the growth of plant height, stem thickness, leaf length and leaf width of pepper seedlings; can significantly improve the number of flowering and fruiting of peppers at the same time; and has the effect of increasing yield of pepper. Its optimal concentration is 0.2 ppm.

TABLE 17
Effect Of Kochia Fruit 100% Ethanol Extract On Pepper Growth 15 Days After Treatment

| | | Plant height | Stem diameter | Leaf length | growth rate |
|---|---|---|---|---|---|
| | Concentration | growth rate | growth rate | growth rate | Leaf width |
| | (ppm) | (%) | (%) | (%) | (%) |
| Kochia fruit | 0.2 | 42.0 | 8.37 | 11.2 | 40 |
| 100% ethanol | 2 | 41.3 | 8.26 | 10.3 | 3.9 |
| control (water only) | — | 40.9 | 8.04 | 9.3 | 3.4 |

TABLE 18
Effect Of Kochia Fruit 100% Ethanol Extract On Growth Of Pepper 30 Days After Treatment

| | | Plant height | Stem diameter | Leaf length | Leaf width |
|---|---|---|---|---|---|
| | Concentration | growth rate | growth rate | growth rate | growth rate |
| | (ppm) | (%) | (%) | (%) | (%) |
| Kochia fruit | 0.2 | 52.2 | 11.36 | 11.7 | 4.7 |
| 100% ethanol extract | 2 | 51.8 | 10.72 | 11.6 | 45 |
| control (water only) | — | 50.4 | 9.95 | 10.6 | 4.1 |

TABLE 19
Effect Of Kochia Fruit 100% Ethanol Extract On Pepper
Flower And Fruit Growth 43 Days After Treatment

| | | Number of flowers | Number of fruits |
|---|---|---|---|
| | Concentration | blooming per plant | [symbol] eces/15 plants) |
| | (ppm) | (flowers/15 plants) | [symbol] |
| Kochia fruit | 0.2 | 187 | 129 |
| 100% | | | |
| ethanol extract | 2 | 172 | 123 |
| control (water | — | 147 | 116 |
| only) | | | |

[symbol]

indicates data missing or illegible when filed

### Example 10: Field Experiment on the Effect of Kochia Fruit Extract Combined Compound Fertilizer on the Growth of Chinese Cabbage

Experimental sample: The Kochia fruit ethyl acetate extract in Example 2 was prepared with water as a mother solution with a concentration of 1% (w/v, 1 g of concentrated extract in 100 ml pure water) and then diluted with water according to Table 20.

TABLE 20
Sample Concentrations

| No. | Treatment | Concentration (ppm) |
|---|---|---|
| 1 | Kochia fruit ethyl acetate extract | 0.2 |
| 2 | | 2 |
| 3 | control (water only) | — |

A total of 3 treatment groups were tested in the experiment, and each treatment covers 100 square meters. An organic carbon compound fertilizer was used as the base fertilizer (N+P+K≥10 wt %, organic carbon ≥30 wt %), and sprinkler irrigation was used. The plant height, leaf width, and leaf number of different treatment groups were tracked and investigated 8 days after sample application.

The experimental results are shown in Table 21. The results show that 0.2-2 ppm of Kochia fruit ethyl acetate extract can significantly promote the growth of the plant height and leaf width of Chinese cabbage and can increase the number of leaves in the plant. The optimal concentration is 0.2 ppm.

TABLE 21
Effect Of Kochia Fruit Ethyl Acetate Extract On The
Growth Of Chinese Cabbage 8 Days After Treatment

| | Concentration | Plant | Leave | Leave |
|---|---|---|---|---|
| | (ppm) | height ( [symbol] ) | width ( [symbol] ) | number |
| Kochia fruit ethyl | 0.2 | 7.5 | 3.5 | |
| acetate extract | 2 | 7.0 | 3.1 | 3. |
| control (water only) | — | 6.2 | 2.7 | 2 |

[symbol]

indicates data missing or illegible when filed

### Example 11: Field Experiment on the Effect of Kochia Fruit Methanol Extract Combined with Root Irrigation Treatment and Compound Fertilizer on the Growth of Lettuce

Experimental sample: The methanol extract in Example 2 was prepared with water as a mother solution with a concentration of 1% (w/v, 1 g of concentrated extract in 100 ml pure water) and then diluted with water according to Table 22.

TABLE 22
Sample Concentrations

| No. | Treatment | Concentration (ppm) |
|---|---|---|
| 1 | Kochia fruit methanol extract | 0.2 |
| 2 | | 2 |
| 3 | control (water only) | — |

2 concentrations were tested, each treatment was applied to three plots, each treatment was applied to 180 plants, each plant was irrigated with 150 ml of sample at root, and compound fertilizer (N/P/K wt % being 24 wt %/10 wt %/16 wt % respectively) was used as the base fertilizer. The plant height, crown width, leaf width, leaf number and stem diameter were tracked before and 10 days after application of the samples.

The experimental results are shown in Table 23. The results show that the Kochia fruit methanol extract of 0.2-2 ppm can significantly promote the growth of lettuce seedlings plant height, crown width, leaf width and stem diameter, and its optimum concentration is 0.2 ppm.

TABLE 23
Effect Of Kochia Fruit Methanol Extract On The
Growth Of Lettuce 10 Days After Treatment

| | | Plant height | Crown width | Leave width | Stem diameter |
|---|---|---|---|---|---|
| | Concentration | growth rate | growth rate | growth rate | growth rate |
| | (ppm) | (%) | (%) | (%) | (%) |
| Kochia fruit | 0.2 | 138.3 | 186.4 | 119.9 | 5.7 |
| methanol | 2 | 128.7 | 161.1 | 117.6 | 5.1 |
| control (water only) | — | 123.1 | 158.7 | 110.7 | 4.5 |

### Example 12: Preparation of Extracts from Different Parts of Kochia

The roots, stems and leaves of the Kochia plant were separated, dried and crushed for later use.

A certain amount of each of the crushed Kochia root, stem and leaf was provided, and 8 times of the volume of 20% ethanol was added, the mixture was ultrasonicated at room temperature for 30 minutes. The steps were repeated twice. The filtrates were combined, filtered through a 0.45 m filter membrane and entered the liquid phase for detection. The obtained samples each were concentrated under reduced pressure to a weight ratio of 1:1 (that is, 1 g of the original material corresponds to 1 g of the concentrated extract) for activity testing.
Chromatographic detection conditions are as follows:
Chromatograph: Agilent 1260
Chromatographic column: Agilent Eclipse Plus C18, (46×250 mm, 5 m)
Column temperature: 35° C.
Detection wavelength: 355 nm;
Injection volume: 10 μL;
Flow rate: 0.8 mL/min;

### Mobile Phase Gradient Elution Conditions (Table 24):

| Time (min) | Acetonitrile % | 0.05% Phosphate water % |
|---|---|---|
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

The detection spectra of different extracted samples of Kochia roots, stems and leaves are shown in FIGS. 17-19. In the chromatogram of the Kochia root extract, the characteristic peaks include 4.1±0.5 min; in the chromatogram of the Kochia stem extract, the characteristic peaks include 4.1±0.5 and 18.6±0.5 min; and in the chromatogram of the Kochia leaf extract, the characteristic peaks include 4.1±0.5 and 18.6±0.5 min.

### Example 13: The Growth-Promoting Effect of Extracts from Different Parts of Kochia on Tobacco Growth

Experimental samples: 20% ethanol extract of Kochia root, 20% ethanol extract of Kochia stem, 20% ethanol extract of Kochia leaf (Example 12) and 20% ethanol extract of Kochia fruit (Example 2) each were prepared with water as a mother solution with a concentration of 1% (w/v, 1 g of concentrated extract in 100 ml pure water) and then diluted with water according to Table 25.

TABLE 25
Sample Concentrations

| No. | Treatment | Concentration (ppm) |
|---|---|---|
| 1 | Kochia root 20% ethanol extract | 2 |
| 2 | | 0.2 |
| 3 | | 0.02 |
| 4 | Kochia stem 20% ethanol extract | 2 |
| 5 | | 0.2 |
| 6 | | 0.02 |
| 7 | Kochia leaf 20% ethanol extract | 2 |
| 8 | | 0.2 |
| 9 | | 0.02 |
| 10 | Kochia 20% ethanol extract | 2 |
| 11 | | 0.2 |
| 12 | | 0.02 |
| 13 | control (water only) | — |

The leaves of the tobacco seedlings were evenly sprayed by the samples, and each sample was applied to 6 plants. Each sample was sprayed in an amount that ensured the sample did not drip onto the soil to prevent any sample entering the soil from affecting the experimental results. The plants were cultivated at 28° C. with 2000 lux light for 14 h and 10 h darkness and humidity of 65%. The plant phenotype analysis system was used to record the tobacco leaf area (mm²) before and 5 days after the treatment, and the leaf area growth rate was calculated to evaluate the growth-promoting effect of each sample. The leaf area growth rate calculation formula is as follows:

$$Leaf area growth rate ( \% ) = ( final leaf area - initial leaf area ) \times 100 / initial leaf area$$

The growth rates of leaf area of different treatment groups 7 days after treatment are shown in Table 26. The results show that the extracts of Kochia roots, stems, leaves and fruits all have different degrees of growth-promoting effects on tobacco growth at a concentration range of 0.02-2 ppm. The growth-promoting effect is as follows: Kochia fruit extract >Kochia leaf extract >Kochia root extract >Kochia stem extract.

TABLE 26
The Growth-Promoting Effect Of Kochia Extracts On Tobacco

| | Concentration | 7-day leaf area |
|---|---|---|
| [symbol] | (ppm) | growth rate (%) |
| | 2 | 586.18 |
| | 0.2 | 611.73 |
| | 0.02 | 541.26 |
| | 2 | 516.94 |
| | 0.2 | 587.50 |
| | 0.02 | 521.54 |
| Kochia leaf 20% | 2 | 632.85 |
| ethanol extract | 0.2 | 724.82 |
| | 0.02 | 693.15 |
| Kochia fruit 20% | 2 | 782.39 |
| ethanol extract | 0.2 | 874.12 |
| | 0.02 | 803.19 |
| control (water only) | — | 513.85 |

[symbol]

indicates data missing or illegible when filed

### Example 14: Promoting Rice Germination with Different Concentrations of Kochia Extracts

The Kochia fruit 20% ethanol extract in Example 2 was prepared with water into a mother solution of a concentration of 1% (w/v, 1 g of concentrated extract in 100 ml pure water) and then diluted with water according to Table 27.

TABLE 27
Sample Concentrations

| No. | Treatment | Concentration (ppm) |
|---|---|---|
| 1 | Kochia fruit 20% ethanol extract | 0.01 |
| 2 | | 0.2 |
| 3 | | 1 |
| 4 | | 20 |
| 5 | | 200 |
| 6 | control (water only) | — |

The crops tested in this experiment are rice seeds. The germination rate of rice seeds was tested to be above 90%. Five concentrations, namely 0.01, 0.2, 1, 20 and 200 ppm, for each Kochia extract were tested to test the effective concentration range of the Kochia extract.

Normal plump seeds were selected, soaked and disinfected with 5% sodium hypochlorite for 15 minutes and then washed repeatedly with clean water 6-7 times. Filter paper was used to absorb the surface moisture of the rice seeds, and the rice seeds were soaked with the Kochia extract samples for 24 hours. Then, 40 normal and plump seeds were selected and placed evenly in a culture box lined with filter paper. 15 mL of water was added to each box to completely soak the filter paper, and the culture boxes were placed in a constant temperature incubator for germination culture for 14 h with light at 28° C. and for 10 h in the dark at 25° C. each day, for 7 days. Germination potential was measured after 3 days, shoot length and root length were measured after 7 days, and root vitality and shoot vitality index were calculated.

$$Germination potential ( \% ) = number of germinated seeds on the third day / total number of seeds \times 100$$

$$Germination rate ( \% ) = number of germinated seeds on the seventh day / total number of seeds \times 10 \; 0$$

$$Root viality index = number of germinated seeds on the seventh day / total number of seeds \times average root length of germinated seedlings \times 100$$

$$Bud viality index = number of germinated seeds on the seventh day / total number of seeds \times average sprout length of germinated seedlings \times 100$$

The results are shown in Table 28. The results show that Kochia extract can promote the germination of rice seeds in the concentration range of 0.01˜200 ppm. Soaking seeds with Kochia extract at different concentrations can improve the germination of rice seeds. It can improve the germination rate and germination potential of rice, promote the growth of rice root length and bud length, and improve its root and bud vitality index, among which the best effect is at 1 ppm concentration.

TABLE 28

| | | Germination | Germination | Root | Bud | Root | Bud |
|---|---|---|---|---|---|---|---|
| | Concentration | potential | rate | length | length | vitality | vitality |
| Treatment | (ppm) | (%) | (%) | (cm) | (cm) | index | index |
| Kochia | 0.01 | 69.03 | 98.07 | 4.76 | 8.00 | 4.67 | 7.85 |
| fruit 20% | 0.2 | 77.69 | 99.33 | 5.32 | 8.11 | 5.28 | 8.06 |
| ethanol | 1 | 82.42 | 100.00 | 5.74 | 8.65 | 5.74 | 8.65 |
| extract | 20 | 78.77 | 100.00 | 5.44 | 8.02 | 5.44 | 8.02 |
| | 200 | 67.46 | 98.29 | 4.59 | 7.69 | 4.51 | 7.56 |
| water | — | 62.02 | 98.09 | 4.38 | 7.01 | 4.30 | 6.88 |

1. A composition comprising Kochia extract.

2. The composition of claim 1, wherein the Kochia extract comprises an extract from a part of a Kochia scoparia (L.) Schrad plant, and the part is selected from the group of root, stem, leaf, fruit, and mixtures thereof.

3. The composition of claim 2, wherein the part is fruit.

4. The composition of claim 1, wherein the composition is in a form selected from the group consisting of cream, suspension, powder, granule, and solution.

5. The composition of claim 1, wherein the Kochia extract is an extract of water and/or an organic solvent.

6. The composition of claim 5, wherein the organic solvent is selected from the group consisting of alcohol, ester, ketone, sherwood oil, and mixtures thereof.

7. The composition of claim 6, wherein the alcohol is selected from the group consisting of ethanol, hydrous ethanol, methanol, hydrous methanol, n-butanol, hydrous n-butanol, and mixtures thereof; the ester is selected from the group consisting of ethyl acetate, methyl acetate, and mixtures thereof; and the ketone comprises acetone.

8. The composition of claim 1 further comprising a material selected from the group consisting of dispersants, wetting agents, binders, emulsifying agents, stabilizers, solvents, and mixtures thereof.

9. The composition of claim 1 further comprising a component selected from the group consisting of foliar fertilizers, water-soluble fertilizers, compound fertilizers, pesticides, and mixtures thereof.

10. The composition of claim 1, wherein the composition comprises the Kochia extract in a concentration of 0.01˜200 ppm.

11. The composition of claim 1, wherein when the composition is being tested by high performance liquid chromatography at conditions comprising:
column: C18
mobile phase gradient elution conditions:

| Time | Acetonitrile | 0.01-1.0% Acid |
|---|---|---|
| (min) | % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

the acid aqueous solution comprises an acid selected from phosphoric acid, acetic acid,
formic acid, trifluoroacetic acid, and mixtures thereof,
a concentration of the aqueous acid solution is 0.01˜0.2%,
column temperature: 30-40° C.,
detection wavelength: 355±5 nm, and
flow rate: 0.5˜1.2 mL/min,
a chromatogram for the composition has at least 90% similarity with at least one of the following:
when the Kochia extract is a Kochia fruit extract, characteristic peaks include one or more of 4.1±0.5 min, 18.6±0.5 min, or 25.4±0.5 min;
when the Kochia extract is a Kochia root extract, characteristic peaks include at least 4.1±0.5 min;
when the Kochia extract is a Kochia stem extract, characteristic peaks include at least one or more of 4.1±0.5 or 18.6±0.5 min; or
when the Kochia extract is a Kochia leaf extract, characteristic peaks include at least one or more of 4.1±0.5 or 18.6±0.5 min.

12. A method of promoting plant growth, the method comprising treating a plant with a composition comprising Kochia extract.

13. The method of claim 12, wherein the Kochia extract comprises an extract from a part of a Kochia scoparia (L.) Schrad plant, and the part is selected from the group of root, stem, leaf, fruit, and mixtures thereof.

14. The method of claim 13, wherein the part is fruit.

15. The method of claim 12, wherein the composition comprises the Kochia extract in a concentration of 0.01˜200 ppm.

16. The method of claim 12 further comprising treating the plant with another composition selected from the group consisting of foliar fertilizers, water-soluble fertilizers, compound fertilizers, pesticides, and mixtures thereof.

17. The method of claim 12, wherein the promoting plant growth is selected from the group consisting of promoting seed germination; promoting growth of one or more of roots, stems, leaves or flowers and fruits; and combinations thereof.

18. The method of claim 12, wherein the plant is selected from the group consisting of tobacco leaves, corn, lettuce, wheat, capsicum, Chinese cabbage, lettuce, Brassica chinensis L., tomato, citrus, kiwi, cherry, pear, apple, and combinations thereof.

19. The method of claim 12, wherein the treating the plant is selected from the group consisting of soaking a seed of the plant, spraying a leaf of the plant, irrigating a root of the plant, and combinations thereof.

20. The method of claim 12 comprising testing the composition by high performance liquid chromatography at conditions comprising:
column: C18
mobile phase gradient elution conditions:

| Time | Acetonitrile | 0.01-1.0% Acid |
|---|---|---|
| (min) | % | aqueous solution |
| 0 | 10 | 90 |
| 10 | 10 | 90 |
| 55 | 45 | 55 |
| 65 | 75 | 25 |
| 70 | 75 | 25 |
| 80 | 45 | 55 |
| 85 | 10 | 90 |
| 90 | 10 | 90 |

the acid aqueous solution comprises an acid selected from phosphoric acid, acetic acid,
formic acid, trifluoroacetic acid, and mixtures thereof,
a concentration of the aqueous acid solution is 0.01˜0.2%,
column temperature: 30-40° C.,
detection wavelength: 355±5 nm, and
flow rate: 0.5˜1.2 mL/min, and
obtaining a chromatogram having at least [90%] similarity with at least one of the following:
when the Kochia extract is a Kochia fruit extract, characteristic peaks include one or more of 4.1±0.5 min, 18.6±0.5 min, or 25.4±0.5 min;
when the Kochia extract is a Kochia root extract, characteristic peaks include at least 4.1±0.5 min;
when the Kochia extract is a Kochia stem extract, characteristic peaks include at least one or more of 4.1±0.5 or 18.6±0.5 min; or
when the Kochia extract is a Kochia leaf extract, characteristic peaks include at least one or more of 4.1±0.5 or 18.6±0.5 min.
